(19) United States
(12) Patent Application Publication
(10) Pub. No.: US 2013/0294594 A1
(43) Pub. Date: Nov. 7, 2013

(54) AUTOMATING THE IDENTIFICATION OF MEETING ATTENDEES

(71) Applicants: Steven Chervets, Longmont, CO (US); Stephan Edward Friedl, Frederick, CO (US)

(72) Inventors: Steven Chervets, Longmont, CO (US); Stephan Edward Friedl, Frederick, CO (US)

(21) Appl. No.: 13/464,788

(22) Filed: May 4, 2012

(51) Int. Cl. H04M 3/42

(52) U.S. Cl. 379/202.01

(57) ABSTRACT

In an example embodiment, there is disclosed herein an apparatus for automatically identifying attendees in a conference call. A social graph associated with a first meeting attendee is searched to identify a second, unknown attendee. For example, the apparatus may search the social graph for a matching voice print, and/or matching facial recognition characteristics in order to identify the unknown attendee.

### TECHNICAL FIELD

The present disclosure relates generally to multi-party conference calls.

### BACKGROUND

Multi-party conference calling allows meeting attendees from various locations to collaborate. Some conferencing programs, such as WebEx available from Cisco Systems, Inc., 170 West Tasman Dr., San Jose, Calif. 9513, provide data identifying the person who is currently speaking. This can be a very convenient feature, for example, if a meeting attendee does not recognize a voice or is not familiar with the person speaking, the meeting attendee can determine the identity of the speaker.

### BRIEF DESCRIPTION OF THE DRAWINGS

The accompanying drawings incorporated herein and forming a part of the specification illustrate the example embodiments.

FIG. 1 is a block diagram illustrating an example of an apparatus for automating the identification of meeting attendees.

FIG. 2 is a block diagram illustrating an example of a conference call with a conferencing server that determines the identity of attendees.

FIG. 3 is a block diagram of a computer system upon which an example embodiment can be implemented.

FIG. 4 illustrates an example of a methodology for identifying meeting attendees.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus for automatically identifying attendees in a conference call. A social graph associated with at least one meeting attendee is searched to identify an unknown attendee. For example, the apparatus may search the social graph for a matching voice print, and/or matching facial recognition characteristics in order to identify the unknown attendee.

### Description of Example Embodiments

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment disclosed herein, there is described a system that can identity people attending a conference call via any one, or combination, of voice recognition software and human analysis. For example, participants may be identified by looking at the attendance roster and matching up voice prints on record.

In an example embodiment, if a participant cannot be identified by matching voice prints on record with the attendance roster, a search is made for people based on one degree of separation within a corporate directory. If a match is still not found, a two degree of separation search can be used.

In an example embodiment, if a participant cannot be readily identified, a search may be made of signatures from prior meeting attendance lists, instant messaging (IM), and/or email correspondence relationships to attempt to identify a participant.

In an example embodiment, the location of the video or audio conference can be used to prune the social graph for identifying attendees. Since most people attend conference calls from specific conference rooms, this can dramatically decrease the problem space. For example, if a conference room is usually used by 10 unique individuals, then an initial identification step would be to check the attendees list, and then check the pool of people who usually use the specific conference room. For example, if a conference room is on the Research Triangle (North Carolina) campus, then individuals located on the San Jose campus could be eliminated from the roster of possible matches.

In an example embodiment, a further filtering process for a conference call using a social graphs could employ real-time or near real-time location information accumulated from network elements like the MSE (Mobility Services Engine) and ISE (Internet Services Engine) to prune the social graph based on the known physical location of individuals with respect to the location of the audio or video teleconferencing unit.

In an example embodiment, the identification algorithm attempts to match existing voice prints to the active speaker. For high confidence matches, the person will be named. For lower confidence matches, the identified name may be italicized, or identified by changing the color of the name.

In an example embodiment, the identification algorithm may allow the other meeting participants to confirm whether the low confidence name identification is accurate or not. For example, a “yes” and “no” button may be provided to allow a conference attendee to indicate if the person has been identified correctly. If the “no” button is pressed, the system can change the name to the next highest probability match.

In an example embodiment, a drop down menu with possible names may be provided to aid in identifying unknown or low probability users. The names on the drop down menu can be the results of a company directory search, as well as IM and email searches for attendees social graphs.

In an example embodiment, attendees may be allowed to identify a speaker manually by allowing attendees to enter the speaker's name. At this point, the system will match the speaker to a corporate directory user and create a voice signature which will be stored for that user.

In an example embodiment, for calls with streaming video, such as Telepresence™ available from Cisco Systems, Inc. 170 West Tasman Dr., San Jose, Calif. 95134, is provided, the names of attendees would be displayed below their video feed. In particular embodiments, facial recognition technology may be employed to identify participants. In an example embodiment, voice recognition technology, meeting attendee lists, and in particular embodiments attendee social graphs, and/or feedback from other attendees can be employed to identify a meeting attendee.

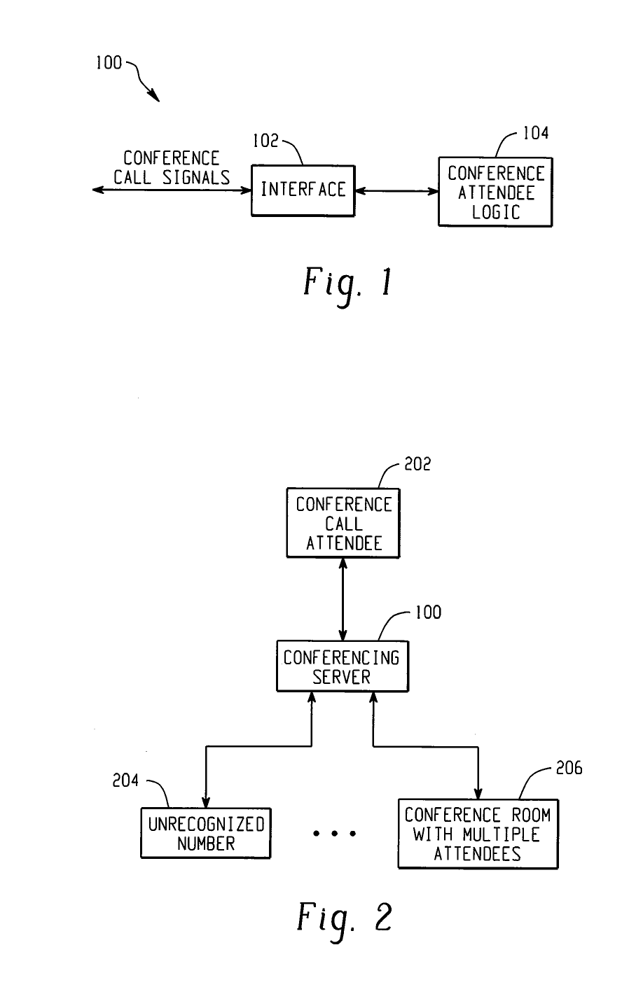

FIG. 1 is a block diagram illustrating an example of an apparatus 100 for automating the identification of meeting attendees. The apparatus 100 comprises an interface 102, and conference attendee logic 104.

The interface 102 may be any suitable wired or wireless interface that can send and receive signals from the conference call. In the illustrated example, a single interface 102 is illustrated; however, those skilled in the art should readily appreciate that a single interface 102 is illustrated merely for ease of illustration and that the example embodiments described herein may suitably comprise any physically realizable number of interfaces 102.

The conference attendee logic 104 receives data from the conference call via the interface 102 and is operable to identify attendees of the conference call. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In an example embodiment, the conference attendee logic 104 identifies a first conference call attendee. The conference attendee logic 104 may employ any suitable technique for identifying the first conference call attendee. For example, if conference call attendee calls in from a number associated with the conference call attendee listed on the roster of scheduled conference call attendees, the conference attendee logic 104 may assume the identity of the caller is the person associated with the phone number and/or may verify the identity of the caller via a voice print, greeting (for example, after a host or other participant greets the meeting participant, e.g., says “hello”, a meeting participant, or participants, may state their name in response, such as “hello this is X”), and/or facial recognition technology. In particular embodiments, the first conference call' attendee may be authenticated. In an example embodiment, a request may be sent to a device associated with first conference call attendee via the interface 102 requesting that first conference call attendee provide an identity, which the conferencing server may receive from the device associated with conference call attendee.

The conference attendee logic 104 attempts to identify a second caller. The conference attendee logic 104 may try to match voice prints from the roster of scheduled meeting attendees. If the conference attendee logic 104 is unable to identify the second caller, the conference attendee logic 104 may search a social graph associated with first caller and/or other attendees from the roster of attendees scheduled for the conference call in order to attempt to identify the second caller.

For example, a corporate directory associated with the first conference caller and/or other attendees listed on the roster of scheduled attendees for the conference call may be searched. For a small company, the entire company directory may be searched. For larger companies, the search may be limited to locations or departments associated with the first caller and/or other attendees listed on the roster of scheduled attendees. In an example embodiment, a search is conducted of a corporate directory for people that are within one level (e.g., people who report to the attendee or people the attendee report to, and/or members within the same level of the organizational charge of the attendee). In another example embodiment, a search may be conducted of two or more levels of the corporate directory.

In an example embodiment, the search of the social graph comprises attendees of previous meetings attended, first attendee and/or other members of the roster of scheduled meeting attendees. Optionally, the search may be limited to a predefined time period (such as within the last month).

In an example embodiment, the search of the social graph comprises persons exchanging Instant Messages with the at least one first attendee. Optionally, the search may be limited to persons having the same employer as the person whose social graph is being searched and/or limited to a predetermined time period.

In an example embodiment, the search of the social graph comprises persons exchanging email messages with the at least one first attendee. Optionally, the search may be limited to persons having the same employer as the person whose social graph is being searched and/or limited to a predetermined time period.

In an example embodiment, the conference attendee logic 104 may filter the social graph to attendees of previous conference calls at the same location associated with the first attendee and/or members of the roster of scheduled meeting attendees. For example, the conference attendee logic 104 may obtain data representative of a location of members of the social graph for first attendee and/or the scheduled attendees. Location data may be obtained from a mobility services engine (MSE) and/or an Internet Services Engine (ISE), using any suitable technique such as badge access data, global positioning satellite (GPS) data, cellular triangulation, etc. The conference attendee logic 104 may filter the social graph to members of the social graph that are currently at the same location as the second attendee.

In an example embodiment, the conference attendee logic 104 determines a plurality of potential matches for the second attendee. The conference attendee logic 104 provides data representative of a first best match for the second attendee. In particular embodiments, the data representative of a first best match comprises data representative of a confidence indication to attendees of the conference call. For example, an icon may be employed to indicate a confidence level (for example a question mark may be employed to indicate a low confidence level). Other examples may include italicizing the name of a low confidence match and/or displaying the names of attendees in different colors where the color indicates the confidence of the match. If the conference attendee logic 104 receives data indicating that the first best match for the second attendee, the conference attendee logic 104 provides data representative of a second best match for the second attendee.

In an example embodiment, the conference attendee logic 104 provides data representative of a plurality of matches for the second attendee. This may allow a device associated with the first attendee, or any other meeting attendee to display names in a menu format and allow the meeting attendees to select the appropriate identity of an attendee. The results of a selection would be communicated to conference attendee logic 104. The conference attendee logic 104 is responsive to receiving data representative of a selection from the plurality of matches by a meeting attendee to associate a name associated with the selection with the second attendee.

Although the preceding example embodiments are directed to searching a social graph of a first meeting attendee, those skilled in the art can readily appreciate that the social graphs for a plurality of attendees may be searched. For example, social graphs of multiple attendees may be searched one at a time (e.g., sequentially) and/or concurrently.

FIG. 2 is a block diagram illustrating an example of a conference call with a conferencing server 100 that determines the identity of attendees. In the illustrated example, the conference call is attended by a first conference call attendee 202, a second conference call attendee 204 connected via an unrecognized number, and a conference room with a plurality of attendees 206.

In an example embodiment, the conference server 100 identifies the first conference call attendee 202. The conference server 100 may employ any suitable technique for identifying the first conference call attendee 202. For example, if conference call attendee calls in from a number associated with the conference call attendee 202 listed on the roster of scheduled conference call attendees, the conference server 100 may assume the identity of the caller is the person associated with the phone number and/or may verify the identity of the caller via a voice print and/or facial recognition technology. In particular embodiments, the conference call attendee 202 may be authenticated. In an example embodiment, a request may be sent to a device associated with first conference call attendee 202 requesting that first conference call attendee 202 provide an identity, which the conferencing server 100 may receive from the device associated with conference call attendee 202.

The conferencing server 100 attempts to identify the second caller 204 calling from an unrecognized number and the plurality of callers 206 calling from a conference call. The conferencing server 100 may try to match voice prints from the roster of scheduled meeting attendees. If the conferencing server 100 is unable to identify the second caller 204 and/or members of the plurality of conference call attendees 206, the conferencing server 100 may search a social graph associated with first caller 202 and/or other attendees from the roster of scheduled attendees for the conference call in order to attempt to identify the second caller 204 and/or members of the plurality of conference call attendees 206.

For example, a corporate directory associated with the first conference caller 202 and/or other attendees listed on the roster of scheduled attendees for the conference call may be searched. For a small company, the entire company directory may be searched. For larger companies, the search may be limited to locations or departments associated with the first caller 202 and/or other attendees listed on the roster of scheduled attendees. In an example embodiment, a search is conducted of a corporate directory for people that are within one level (e.g., people who report to the attendee or people the attendee reports to, and/or members within the same level of the organizational charge of the attendee). In another example embodiment, a search may be conducted of two or more levels of the corporate directory.

In an example embodiment, the search of the social graph comprises attendees of previous meetings attended, first attendee 202 and/or other members of the roster of scheduled meeting attendees. Optionally, the search may be limited to a predefined time period (such as within the last month).

In an example embodiment, the search of the social graph comprises persons exchanging Instant Messages with the at least one first attendee. Optionally, the search may be limited to persons having the same employer as the person whose social graph is being searched and/or limited to a predetermined time period.

In an example embodiment, the search of the social graph comprises persons exchanging email messages with the at least one first attendee. Optionally, the search may be limited to persons having the same employer as the person whose social graph is being searched and/or limited to a predetermined time period.

In an example embodiment, the conferencing server 100 may filter the social graph to attendees of previous conference calls at the same location associated with the first attendee 202 and/or members of the roster of scheduled meeting attendees. For example, the conferencing server 100 may obtain data representative of a location of members of the social graph for first attendee 202 and/or the scheduled attendees. Location data may be obtained from a mobility services engine (MSE) and/or an Internet Services Engine (ISE). The conferencing server 100 may filter the social graph to members of the social graph that are currently at the same location as the second attendee.

In an example embodiment, the conferencing server 100 determines a plurality of potential matches for the second attendee 204 and/or members of the plurality of attendees 206. The conferencing server 100 provides data representative of a first best match for the second attendee 204 and/or members of the plurality of attendees 206. In particular embodiments, the data representative of a first best match comprises data representative of a confidence indication to attendees of the conference call. For example, an icon may be employed to indicate a confidence level (for example a question mark may be employed to indicate a low confidence level). Other examples may include italicizing the name of a low confidence match and/or displaying the names of attendees in different colors where the color indicates the confidence of the match. If the conferencing server 100 receives data indicating that the first best match for the second attendee 204 and/or a member of the plurality of attendees 206 is inaccurate, the conferencing server 100 provides data representative of a second best match for the second attendee.

In an example embodiment, the conferencing server 100 provides data representative of a plurality of matches for the second attendee 204 and/or members of plurality of attendees 206. This may allow a device associated with first attendee 202, second attendee 204 and/or the plurality of attendees 206 to display names in a menu format and allow the meeting attendees to select the appropriate identity of an attendee. The results of a selection would be communicated to conferencing server 100. The conferencing server 100 is responsive to receiving data representative of a selection from the plurality of matches by a meeting attendee to associate a name associated with the selection with the second attendee.

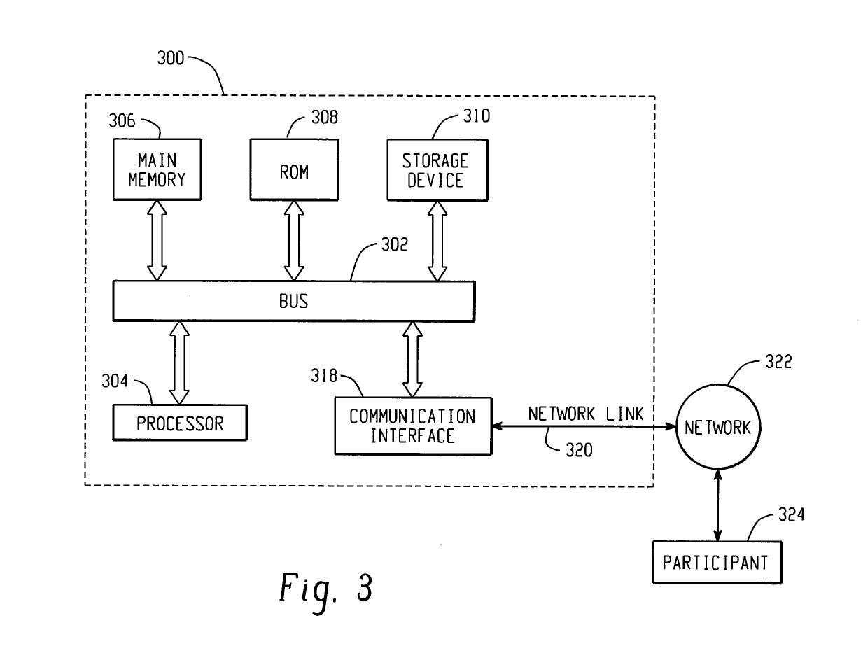

FIG. 3 is a block diagram that illustrates a computer system 300 upon which an example embodiment may be implemented. For example, computer system 300 may be employed for implementing the conference attendee logic 104 described herein in FIG. 1 supra.

Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, optical disk, and/or flash storage, is provided and coupled to bus 302 for storing information and instructions.

An aspect of the example embodiment is related to the use of computer system 300 for automating the identification of meeting attendees. According to an example embodiment, automating the identification of meeting attendees is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media, and volatile media. Non-volatile media include, for example, optical or magnetic disks, such as storage device 310. Volatile media include dynamic memory such as main memory 306. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 300 also includes a communication interface 318 coupled to bus 302. Communication interface 318 provides a two-way data communication coupling computer system 300 to a network link 320 that is connected to a local network 322. For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a meeting participant 324 Although the illustrated example has one communication interface 318 and one participant 324, those skilled in the art should readily appreciate that this is for ease of illustrating as the example embodiments described herein may have any physically realizable number of communication interfaces 318, network links 320, and/or participants 324.

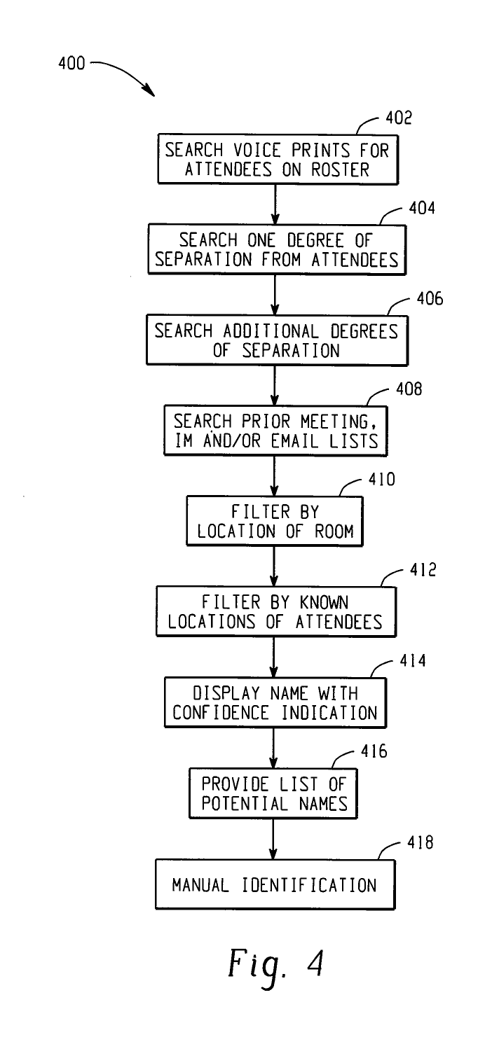

In view of the foregoing structural and functional features described above, a methodology 400 in accordance with an example embodiment will be better appreciated with reference to FIG. 4. While, for purposes of simplicity of explanation, the methodology 400 of FIG. 4 is shown and described as executing serially, it is to be understood and appreciated that the example embodiment is not limited by the illustrated order, as some aspects could occur in different orders and/or concurrently with other aspects from that shown and described herein.

Moreover, in accordance with an example embodiment, not all illustrated features may be required. For example, once a meeting attendee has been identified, any acts or steps that have not yet been performed may be skipped.

The methodology 400 described herein is suitably adapted to be implemented in hardware, software, or a combination thereof. For example, the method 400 may be implemented by conference attendee logic 104 (FIG. 1) and/or by processor 304 (FIG. 3).

At 402, voice prints of meeting attendees are searched in order to identify a meeting attendee. For example, a meeting attendee may be identified by looking at a meeting (or attendance) roster and matching up voice prints of the meeting attendee with voice prints on record. In particular embodiment, such as a video conference, facial recognition may be performed to identify a meeting attendee. For example, a facial recognition algorithm may attempt to match the meeting attendee with the roster of meeting participants.

At 404, a search to identify a meeting attendee is made based on one degree of separation within a corporate directory. For example, based on the roster of known meeting attendees, a search may be made of persons that are one level above, below and/or on the same level on an organizational chart. If a match is still not found, two or more degrees of separation can be used, as illustrated at 406.

At 408, a search may be performed using signatures from prior meeting attendance lists, instant messaging (IM) exchanges, and/or email correspondence relationships of known meeting attendees to attempt to identify a meeting participant. For example, for a first meeting attendee, a search may be made of attendees of past meetings attended by the first meeting attendee, parties involved in IM exchanges with the first meeting attendee, and/or correspondents of email messages with the first meeting participant. If no match is found, the same type of searches may be made for another (e.g., second) meeting participant.

At 410, the location of where an attendee is calling from can be used to filter the search results for identifying attendees. Since most people attend conference calls from specific conference rooms, this can decrease the problem space. For example, if a conference room is usually used by 10 unique individuals, then an initial identification step would be to check the attendees list, and then check the pool of people who usually use the specific conference room. For example, if a conference room is on the Research Triangle (North Carolina) campus, then individuals located on the San Jose campus could be eliminated from the roster of possible matches.

At 412, real-time or near real-time location information accumulated from network elements like the MSE (Mobility Services Engine) and ISE (Internet Services Engine) is employed to filter the results. For example, an individual whose location is not near the source of a connection can be pruned.

At 414, an identification of the best match is provided to meeting attendees. For high confidence matches, the person will be named. For lower confidence matches, the identified name may be italicized, or identified by changing the color of the name.

In an example embodiment, the identification algorithm may allow the other meeting participants to confirm whether a name identified with the low confidence is accurate. For example, “yes” and “no” buttons may be provided to allow conference attendees to indicate if the person has been identified correctly. If the “no” button is pressed, the name of the next highest probability match is displayed.

At 416, a drop down menu with possible names may be provided to aid in identifying unknown or low probability users. The names on the drop down menu can be the results of a company directory search, as well as IM and/or email searches of known meeting attendees social graphs.

At 418, meeting attendees may be allowed to identify a speaker manually by allowing attendees to enter the speaker's name. In an example embodiment, the speaker will be matched to a corporate directory, and a voice signature will be stored for that user.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
an interface operable to communicate with external devices;
conference attendee logic coupled with the interface and operable to receive signals via the interface; and
wherein the conference attendee logic searches a social graph of a first attendee associated with the conference call to identify a second attendee of the conference call.

2. The apparatus set forth in claim 1, wherein the conference attendee logic searches the social graph for a member of the social graph with a voice print that matches the second attendee.

3. The apparatus set forth in claim 1, wherein the conference attendee logic searches the social graph for a member of the social graph with matching facial recognition characteristics.

4. The apparatus set forth in claim 1, wherein the social graph comprises members of a corporate directory that are within one level of the first attendee.

5. The apparatus set forth in claim 1, wherein the social graph comprises members of a corporate directory that are within two levels of the first attendee.

6. The apparatus set forth in claim 1, wherein the social graph comprises attendees of previous meetings attended by the first attendee.

7. The apparatus set forth in claim 1, wherein the social graph comprises persons exchanging Instant Messages with the first attendee.

8. The apparatus set forth in claim 1, wherein the social graph comprises persons exchanging email messages with the first attendee.

9. The apparatus set forth in claim 1, wherein the conference attendee logic filters the social graph to attendees of previous conference calls at a same location associated with the second attendee.

10. The apparatus set forth in claim 1, wherein the conference attendee logic obtains data representative of a location of members of the social graph; and
wherein the conference attendee logic filters the social graph to members of the social graph that are currently at the same location as the second attendee.

11. The apparatus set forth in claim 1, wherein the conference attendee logic determines a plurality of potential matches for the second attendee; and
provides data representative of a first best match for the second attendee and data representative of a confidence indication to attendees of the conference call.

12. The apparatus set forth in claim 11, wherein the conference attendee logic is responsive to receiving data indicating that the first best match for the second attendee is inaccurate to provide data representative of a second best match for the unknown attendee.

13. The apparatus set forth in claim 1, wherein the conference attendee logic provides data representative of a plurality of matches for the second attendee.

14. The apparatus set forth in claim 13, wherein the conference attendee logic is responsive to receiving data representative of a selection from the plurality of matches by a meeting attendee to associate a name associated with the selection with the second attendee.

15. Logic encoded in a non-transitory tangible computer readable medium for execution by a processor and when executed operable to:
obtain a voice print associated with a second attendee of a conference call; and
search a social graph of first attendee of the conference call for a matching voice print to identify the second attendee of the conference.

16. The logic set forth in claim 15, further operable to:
determine a plurality of matches with the voice print associated with the second attendee;
provide data representative of a first best match from the plurality of matches to conference call attendees and data representative of a confidence indication;
receive data indicating the first best match is not the second attendee; and
provide data representative of a next best match from the plurality of matches to conference call attendees.

17. The logic set forth in claim 15, further operable to:
determine a plurality of matches with the voice print associated with the second attendee;
provide data representative of the plurality of matches for the second attendee to conference call attendees;
receive a selection from the data representative of a plurality of matches from a conference call attendee; and
associate an identity associated with the selected match with the second attendee.

18. The logic set forth in claim 15, further operable to filter the social graph based on a location associated with the second attendee.

19. A method, comprising:
obtaining facial recognition data associated with a second attendee of a conference call; and
searching a social graph of a first attendee of the conference call for a matching facial recognition characteristics to identify the unknown attendee of the conference.

20. The method of claim 19, wherein the social graph comprises employees who work for the same employer as the first attendee.
